(19) United States
(12) Patent Application Publication
(10) Pub. No.: US 2016/0119247 A1
(43) Pub. Date: Apr. 28, 2016

(54) AUTOMATIC RESOURCE DELIVERING APPARATUS AND METHOD THEREOF

(71) Applicant: Powerchip Technology Corporation, Hsinchu (TW)

(72) Inventors: Kai-Chun Yen, Hsinchu County (TW); Yeh-Yang Hou, Hsinchu County (TW)

(21) Appl. No.: 14/583,197

(22) Filed: Dec. 26, 2014

(30) Foreign Application Priority Data
Oct. 24, 2014 (TW) 103136814

(51) Int. Cl. H04L 12/923; H04L 12/863

(52) U.S. Cl. CPC H04L 47/762; H04L 47/54

(57) ABSTRACT

An automatic resource delivering apparatus and a method thereof are provided. The automatic resource delivering apparatus includes a control server, a data bank apparatus and a plurality of resource delivering devices. The control server generates a plurality of delivery planning commands according to a plurality of dispatching instructions, respectively. A data bank controller of the data bank apparatus decides whether to enable a flow control scheme according to an amount of the delivery planning commands, and transmits control parameters corresponding to the delivery planning commands to the control server. At least one of the delivering devices executes a resource delivering operation according to an action command generated by the control server. The control server stores each of the delivery planning commands to a command queue in the data bank apparatus according to whether the flow control scheme being enabled and the control parameter corresponding to each delivery planning command.

### CROSS-REFERENCE TO RELATED APPLICATION

This application claims the priority benefit of Taiwan application serial no. 103136814, filed on Oct. 24, 2014. The entirety of the above-mentioned patent application is hereby incorporated by reference herein and made a part of this specification.

### BACKGROUND OF THE INVENTION

1. Field of the Invention

The invention relates to an automatic resource delivering apparatus and a method thereof, and more particularly, relates to an automatic resource delivering apparatus and a method thereof for a semiconductor manufacturing plant.

2. Description of Related Art

In a semiconductor manufacturing plant, with increases in wafer size and production capacity, an automatic resource delivering apparatus has become one of most important devices. In conventional automatic resource delivering apparatus, whenever delivery is required, an action command is directly generated to command resource delivering devices to execute a resource delivering operation.

In a circumstance where demands on production capacity are significantly increased, it is often found that an amount of delivery planning commands exceeds loading of the automatic resource delivering apparatus. Accordingly, the automatic resource delivering apparatus in the conventional technology does not take in consideration of the amount of the delivery planning commands but simply generates a corresponding action command for each of the delivery planning commands. Therefore, when the excessive amount of the action commands is received, the resource delivering devices may crash or a clogging phenomenon may occur due to uneven distribution area for the resource delivering devices. Alternatively, a control server may need to calculate a traveling path of the resource delivering device repeatedly for several times, which leads to delay on the delivery and extra loadings on the control server. Moreover, in the circumstance where the excessive amount of the delivery planning commands, execution of the delivery planning command with high priority may delay or fail due influences by the delivery planning command with low priority.

### SUMMARY OF THE INVENTION

The invention is directed to an automatic resource delivering apparatus and a method thereof for a semiconductor manufacturing plant, which are capable of effectively solving issues including poor resource delivery efficiency or delivery failures due to great amount of dispatching instructions.

The automatic resource delivering apparatus of the invention includes a control server, a data bank apparatus and a plurality of resource delivering devices. The control server generates a plurality of delivery planning commands according to a plurality of dispatching instructions, respectively. The data bank apparatus is coupled to the control server. The data bank apparatus includes a data bank controller. The data bank controller decides whether to enable a flow control scheme according to an amount of the delivery planning commands, and transmits a plurality of control parameters corresponding to the delivery planning commands to the control server. The control server is coupled to a plurality of resource delivering devices. At least one of the delivering devices executes a resource delivering operation according to an action command generated by the control server. The control server decides whether to temporarily store each of the delivery planning commands to a command queue in the data bank apparatus according to whether the flow control scheme being enabled, the control parameter corresponding to each of the delivery planning commands and a control logic, or to generate the action command according to each of the delivery planning commands.

The automatic resource delivering method of the invention is suitable for a semiconductor manufacturing plant. The resource delivering method includes: generating a plurality of delivery planning commands according to a plurality of dispatching instructions, respectively; deciding whether to enable a flow control scheme according to an amount of the delivery planning commands, and transmitting a plurality of control parameters corresponding to the delivery planning commands to the control server; temporarily storing each of the delivery planning commands to a command queue according to whether the flow control scheme being enabled, the control parameter corresponding to each of the delivery planning commands and a control logic, or generating an action command according to each of the delivery planning commands; and executing a resource delivering operation according to the action command.

Based on the above, the invention is capable of temporarily storing parts of the delivery planning commands by using the command queue when the amount of the delivery planning commands is excessive. Accordingly, the control server is capable of processing a limited amount of the delivery planning commands so as to prevent crashes. As a result, the resources may be effectively and immediately transported to the destinations. Moreover, all of the delivery planning commands may be effectively processed, so as to maintain a smoothness and a reliability of the manufacturing process and for the product.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating an automatic resource delivering apparatus 100 according to an embodiment of the invention.

FIG. 2 is a schematic diagram illustrating an automatic resource delivering apparatus 200 according to another embodiment of the invention.

FIG. 3 is a flowchart illustrating an implementation of a complementary resource delivering operation according to an embodiment of the invention.

FIG. 4 is a flowchart illustrating an implementation of a complementary resource delivering operation according to another embodiment of the invention.

FIG. 5 is a flowchart illustrating an automatic resource delivering method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

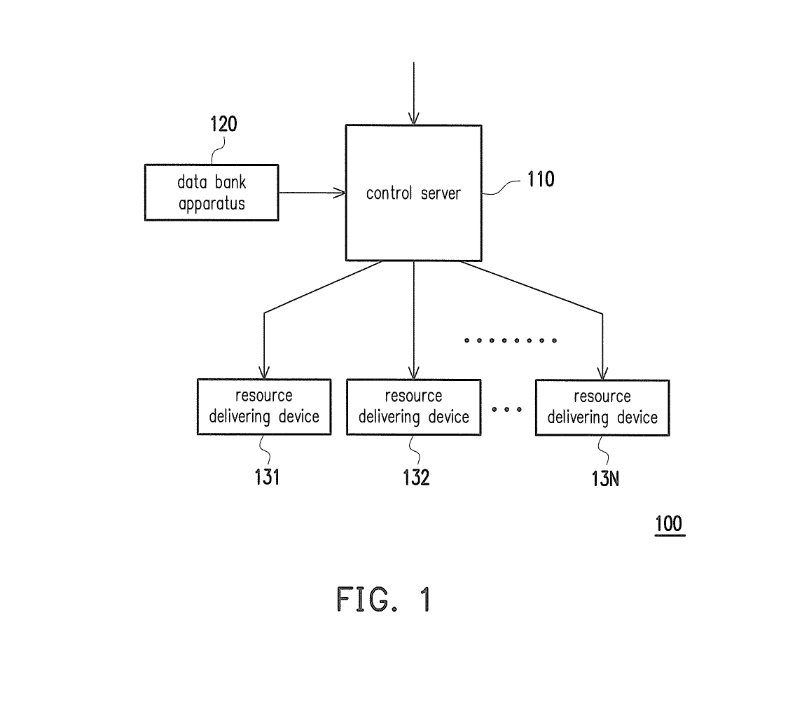

Referring to FIG. 1, which is a schematic diagram illustrating an automatic resource delivering apparatus 100 according to an embodiment of the invention. The automatic resource delivering 100 may be applied in a semiconductor manufacturing plant. The automatic resource delivering apparatus 100 includes a control server 110, a data bank apparatus 120 and a plurality of resource delivering devices 131 to 13N. The resource delivering devices 131 to 13N may be an overhead hoist transport (OHT), an overhead hoist shuttle (OHS), a rail guided vehicle (RGV) and a stoker.

The control server 110 can receive a plurality of dispatching instructions and generate a plurality of delivery planning commands according to the dispatching instructions, respectively. The control server 110 can generate a plurality of action commands for each of the delivery planning commands, and drive one or more of the resource delivering devices 131 to 13N by using each of the generated action commands in order to execute a resource delivering operation.

The data bank apparatus 120 is coupled to the control server 110, and a data bank controller (not illustrated) is included in the data bank apparatus 120. The data bank apparatus 120 is capable of determining an amount of the delivery planning commands by using the data bank controller, and deciding whether to enable a flow control scheme according to the amount of the delivery planning commands. Specifically, when the data bank controller determines that the amount of the delivery planning commands is increased to be greater than a first threshold after a fixed time interval, the data bank controller can decide to enable the flow control scheme. In contrast, when the data bank controller determines that the amount of the delivery planning commands is less than a second threshold after the fixed time interval, the data bank controller can decide to disable the flow control scheme. The first threshold may be greater than the second threshold.

In an embodiment of the invention, the data bank controller can determine whether to enable the flow control scheme by using a watch dog timer. In operation details, the data bank controller can reset the watch dog timer according to aforesaid time interval. In addition, the watch dog timer is capable of counting for the amount of the delivery planning commands. When the amount of the delivery planning commands is raised to be greater than the first threshold, the data bank controller can enable the flow control scheme correspondingly.

If the flow control scheme is not enabled, the control server 110 can generate a corresponding action command according to each of the delivery planning commands, and make the resource delivering devices 131 to 13N to directly execute the delivery planning commands. In contrast, in a circumstance where the flow control scheme is enabled, the control server 110 can process each of the delivery planning commands according to each control logic corresponding to each of the delivery planning commands. In the case where the control server 110 determines that the delivery planning command has relatively high priority, the corresponding action command may be generated directly according to the delivery planning commands in order to command the resource delivering devices 131 to 13N to execute the resource delivering operation. In contrast, in the case where the control server 110 determines that the delivery planning command has relatively low priority, the delivery planning commands may be temporarily stored to a command queue in the data bank apparatus 120.

When a resource delivering carrier (front opening unified pod; FOUP) is transported to the stoker and the delivery planning commands are stored to the command queue in the data bank apparatus 120, the delivery planning commands end automatically. When the flow control scheme is disabled and a plurality of queue delivery commands queued match a set condition, the data bank apparatus 120 can sequentially transmit the queue delivery commands in the command queue to the control server 110. The control server generates a corresponding action command according to the queue delivery commands in order to execute a complementary resource delivering operation for the resource delivering carrier. In addition, when the complementary resource delivering operation for the resource delivering carrier ends, the data, bank apparatus 120 can remove the queue delivery commands from the command queue.

Naturally, whether to execute the complementary resource delivering operation or not must also refer to a plurality of exception conditions. For instance, in a condition where a queued state is set, if the flow control scheme is enabled, the complementary resource delivering operation is stopped. Alternatively, when the queued state is set, the data bank apparatus 120 determines a resource state of a delivery destination corresponding to each of the queue delivery commands stored in the command queue. Further, when the resource state indicates that a resource at the delivery destination corresponding to each of the queue delivery commands is full, the data bank apparatus 120 stops the complementary resource delivering operation corresponding to each of the queue delivery commands. As another example, when the queued state is set, the data bank apparatus 120 can determine a location and a state of the resource delivering carrier corresponding to each of the queue delivery commands. If changes occurred on the location and the state of the resource delivering carrier, the data bank apparatus 120 can stop the complementary resource delivering operation corresponding to each of the queue delivery commands.

It should be noted that, during the complementary resource delivering operation, the data bank apparatus 120 can sequentially transmit each of the queue delivery commands according to a plurality of priorities respectively corresponding to the queue delivery commands. Moreover, during the complementary resource delivering operation, the data bank apparatus 120 can record an execution state of the complementary resource delivering operation.

In addition, in the present embodiment of the invention, the delivery planning commands may be classified into a plurality of local delivery commands and a plurality of inter-regional delivery commands. As such, the data bank apparatus 120 can notify the control server 110 to enable or disable at least one of a local resource delivery and an inter-regional resource delivery. While the data bank apparatus 120 determines whether to enable the flow control scheme, the data bank apparatus 120 can determine an amount of the local delivery commands and an amount of the inter-regional delivery commands separately. More specifically, when the amount the local delivery commands is excessive (greater than the first threshold), the data bank apparatus 120 can enable the flow control scheme corresponding to the local resource delivery.

When the amount of the inter-regional delivery commands is excessive (greater than the first threshold), the data bank apparatus 120 can enable the flow control scheme corresponding to the inter-regional resource delivery. The first threshold of the local delivery commands and the first threshold of the inter-regional delivery commands may be set to be different values.

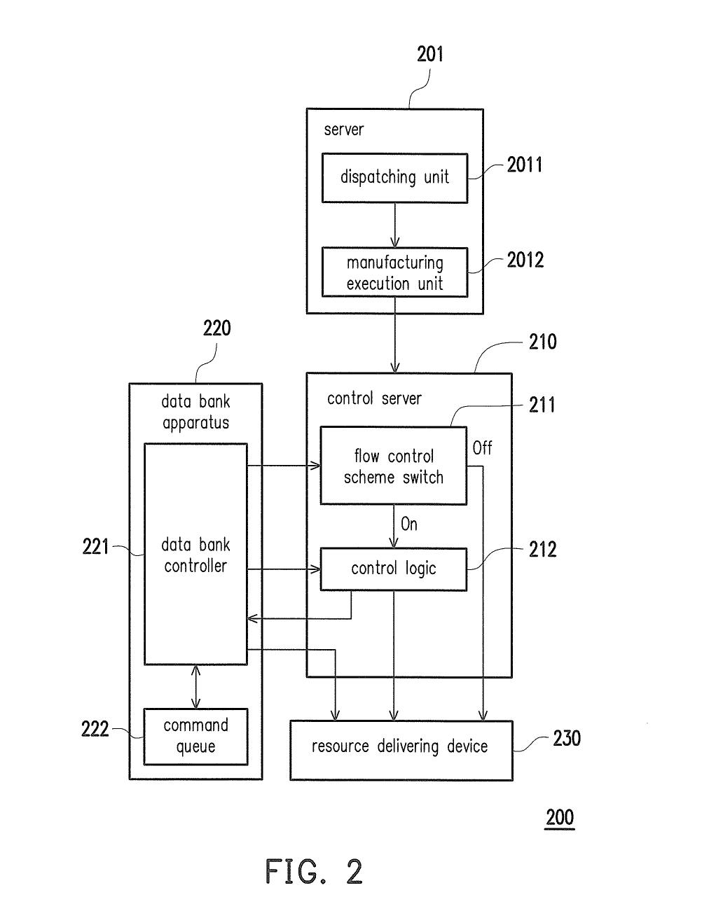

Hereinafter, referring to FIG. 2, which is a schematic diagram illustrating an automatic resource delivering apparatus 200 according to another embodiment of the invention. The automatic resource delivering apparatus 200 includes a server 201, a control server 210, a data bank apparatus 220 and a resource delivering devices 230. The server 201 includes a dispatching unit 2011 and a manufacturing execution unit 2012. The dispatching unit 2011 sends a plurality of dispatching instructions, and the manufacturing execution unit 2012 generates manufacturing execution instructions according to the dispatching instructions, and transmits the manufacturing execution instructions to the control server 210. The control server 210 includes a flow control scheme switch 211 and a control logic 212. The data bank apparatus 220 includes a data bank controller 221 and a command queue 222.

The control server 210 generates a plurality of delivery planning commands according to a plurality of dispatching instructions, respectively. The data bank apparatus 221 controls enable (on) or disable (off) states of the flow control scheme switch 211 according to an amount of the delivery planning commands.

The flow control scheme switch 211 is turned on when a flow control scheme is enabled, and the flow control scheme switch 211 is turned off when the flow control scheme is disabled. When the amount of the delivery planning commands is lower than a second threshold, the data bank controller 221 controls the control server 210 to turn off the flow control scheme switch 211 and generates an action command directly according to the delivery planning commands in order to drive the resource delivering device to execute a resource delivering operation. In contrast, when the amount of the delivery planning commands exceeds the first threshold, the control server 210 turns on the flow control scheme switch 211, and determines whether to temporarily store the delivery planning commands to the data bank apparatus 220 by using the control logic 212, or to generate an action command according to the delivery planning command in order to drive the resource delivering device to execute the resource delivering operation.

The control logic 212 determines a priority of each of the delivery planning commands according to received control parameters. The control parameters are provided by the data bank controller 211. The control logic 212 is a logic operation of a processor of the control server 210. The delivery planning commands determined by the control logic 212 as the delivery planning command with relatively low priority are transmitted to the command queue for temporarily storage, whereas the delivery planning commands determined by the control logic 212 as the delivery planning command with relatively high priority are used by the control server 210 for generating the corresponding action command to be used by the resource delivering device 230 for executing the resource delivering operation.

It is worth mentioning that, in the control logic 212, the delivery planning command which indicates that the resource delivering carrier has been delivered but not yet arrived at the stoker cannot be temporarily stored to the command queue 222. In addition, when the delivery destination of the delivery planning command is an equipment, that delivery planning command cannot be temporarily stored to the command queue 222. Furthermore, the delivery planning command with a specific user authority cannot be temporarily stored to the command queue 222, and the delivery planning command which indicates that the location of the resource delivering carrier is at some specific stokers cannot be temporarily stored to the command queue 222 either.

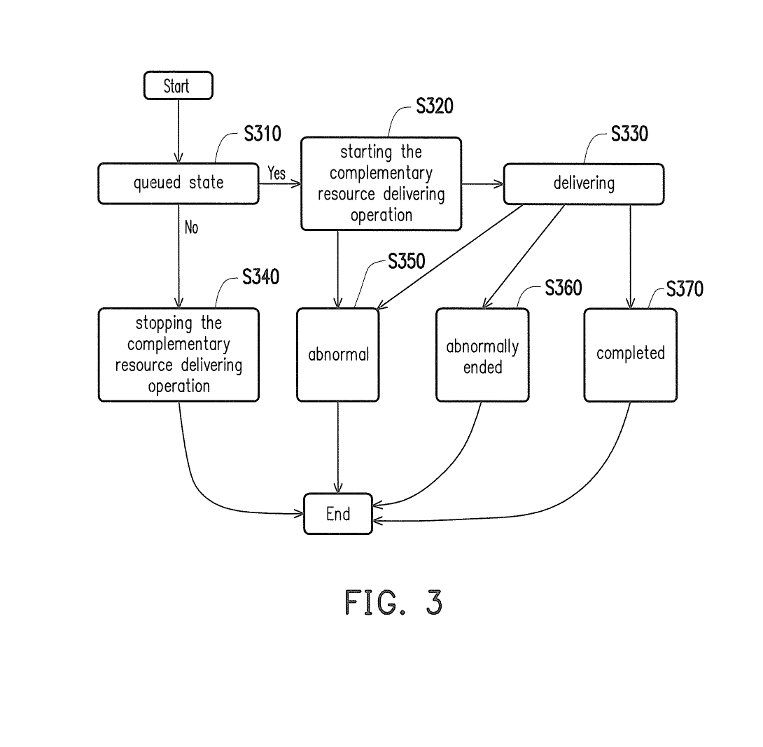

Hereinafter, referring to FIG. 3, which is a flowchart illustrating an implementation of a complementary resource delivering operation according to an embodiment of the invention. In FIG. 3, an initial state of the queue delivery commands is set to be the queued state (state S310). When the complementary resource delivering operation starts (state S320), if the corresponding delivery planning commands cannot be established according to the queue delivery commands, this complementary resource delivering operation is recorded as abnormal (state 350) and the complementary resource delivering operation ends. If the delivery planning commands are established successfully, the resource delivering operation is then executed (state S330).

During the resource delivering operation (S330), if it is detected that the resource cannot be moved to the destination during the delivery, the complementary resource delivering operation is recorded as abnormal (state 350) and the complementary resource delivering operation ends. In addition, if the complementary resource delivering operation is completed yet the resource is not delivered to the original destination, the complementary resource delivering operation is recorded as abnormally ended (state 360) and the complementary resource delivering operation ends. If the complementary resource delivering operation is completed successfully (state S370), the complementary resource delivering operation also ends.

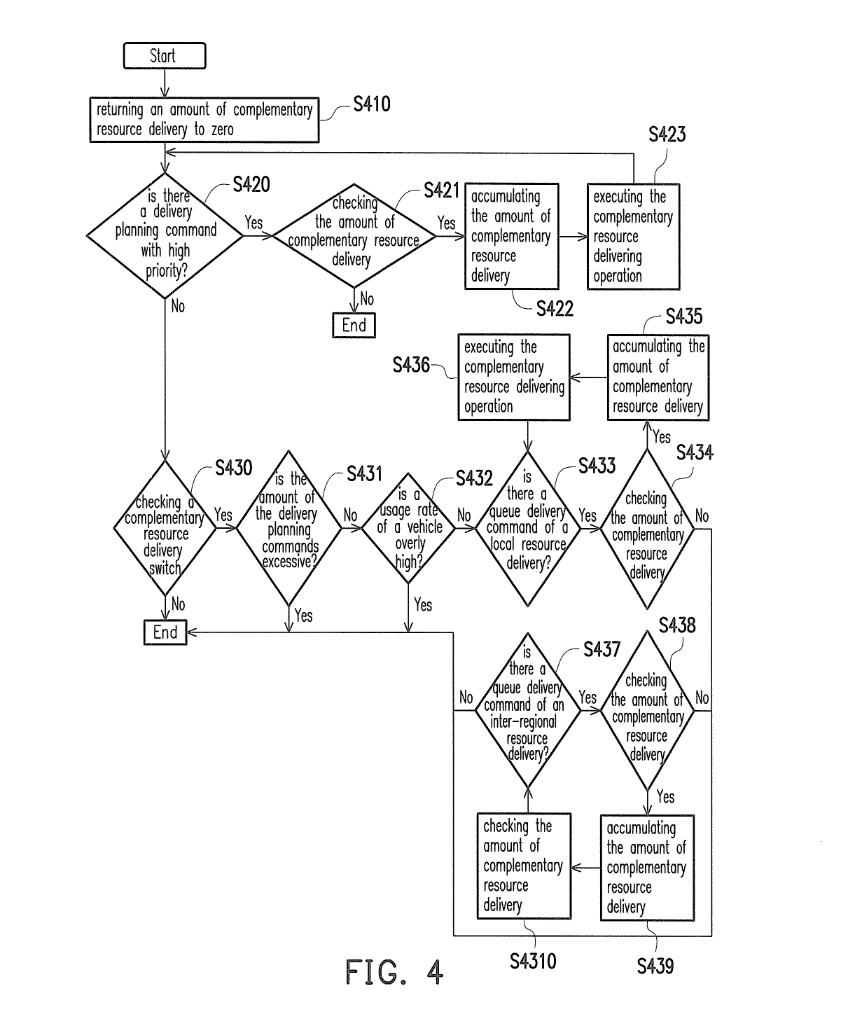

In addition, referring to FIG. 4, which is a flowchart illustrating an implementation of a complementary resource delivering operation according to another embodiment of the invention. In FIG. 4, an amount of complementary resource delivery is returned to zero in step S410. Subsequently, whether the delivery planning command with relatively high priority is in the command queue is determined in step S420. When the delivery planning command with relatively high priority is found, a size of the amount of complementary resource delivery is checked (step S421). If the amount of complementary resource delivery is available for executing the complementary resource delivery operation, the amount of complementary resource delivery is accumulated (step S422), and then the complementary resource delivering operation is executed (step S423). If the amount of complementary resource delivery is not available, the complementary resource delivering operation ends.

If a determined result of step S420 is that the command queue does not include the delivery planning command with relatively high priority, a checking operation for a complementary resource delivery switch is executed in step S430. In a circumstance where the complementary resource delivery switch is disabled, the complementary resource delivering operation ends. In contrast, in a circumstance where the complementary resource delivery switch is enabled, proceeding to step S431 for determining whether a current amount of the delivery planning commands is excessive. If the current amount of the delivery planning commands is excessive, the complementary resource delivering operation ends all the same. If the current amount of the delivery planning commands is not excessive, executing step S432 additionally for determining whether a usage rate of a vehicle (the resource delivering device) is overly high. If the usage rate of the vehicle is overly high, the complementary resource delivering operation ends. Otherwise, if the usage rate of the vehicle is not overly high, proceeding to step S433.

Whether there is the queue delivery command of the local resource delivery is determined in step S433. If yes, the amount of complementary resource delivery is checked (step S434). Then, if the amount of complementary resource delivery is available (the amount of complementary resource delivery does not exceed a maximum value), the amount of complementary resource delivery is accumulated (step S435), and then the complementary resource delivering operation is executed (step S436). Herein, the maximum value of the amount of complementary resource delivery may be a value preset in advance, which can be set and adjusted by engineers based on a working state of the factory.

On the other hand, if it is determined that the queue delivery command for local resource delivery is not present in step S433, proceeding to step S437 for determining whether there is the queue delivery command of the inter-regional resource delivery or not. If a determined result of step S437 is no, the complementary resource delivering operation ends. If a determined result of step S437 is yes, the amount of complementary resource delivery is checked (step S438). Then, if the amount of complementary resource delivery is available (the amount of complementary resource delivery does not exceed the maximum value), the amount of complementary resource delivery is accumulated (step S439), and then the complementary resource delivering operation is executed (step S4310).

Furthermore, in step S434 and step S438, if it is checked that the amount of complementary resource delivery exceeds the maximum value being preset, the complementary resource delivering operation is not executed, and the process of the complementary resource delivery ends.

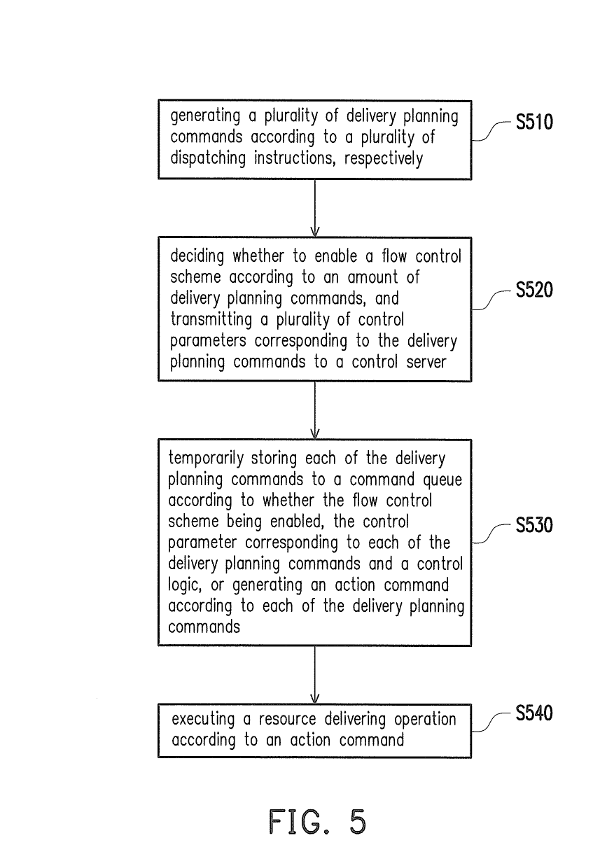

Hereinafter, referring to FIG. 5, which is a flowchart illustrating an automatic resource delivering method according to an embodiment of the invention. In step S510, a plurality of delivery planning commands are generated according to a plurality of dispatching instructions, respectively. In step S520, whether to enable a flow control scheme is decided according to an amount of delivery planning commands, and a plurality of control parameters corresponding to the delivery planning commands are transmitted to a control server. In step S530, each of the delivery planning commands is temporarily stored to a command queue according to whether the flow control scheme being enabled, the control parameter corresponding to each of the delivery planning commands and a control logic, or an action command is generated according to each of the delivery planning commands. Further, in step S540, a resource delivering operation is executed according to the action command.

Relevant implementation detail for the steps above has been described in the previous embodiments and implementations, thus it is omitted hereinafter.

In summary, the invention is capable of temporarily storing the delivery planning commands not requiring real-time processing in the command queue when the amount of the delivery planning commands is excessive, so as to reduce loadings on the control server and the resource delivering devices at the same time. Accordingly, the delivery planning commands may be completed according to an order of the priorities, so as to reduce occurrences of crashes on the control server or the resource delivering devices at the site. Moreover, with restriction by a limited amount of the resource delivering devices, a completion ratio of the delivery planning commands may also be increased to improve an efficiency of the production.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An automatic resource delivering apparatus, comprising:
a control server, generating a plurality of delivery planning commands according to a plurality of dispatching instructions, respectively;
a data bank apparatus, coupled to the control server, the data bank apparatus having a data bank controller, and the data bank controller deciding whether to enable a flow control scheme according to an amount of the delivery planning commands and transmitting a plurality of control parameters corresponding to the delivery planning commands to the control server; and
a plurality of resource delivering devices, coupled to the control server, and at least one of the resource delivering devices executing a resource delivering operation according to an action command generated by the control server,
wherein the control server temporarily stores each of the delivery planning commands to a command queue in the data bank apparatus according to whether the flow control scheme being enabled or not, the control parameter corresponding to each of the delivery planning commands and a control logic, or generates the action command according to each of the delivery planning commands.

2. The automatic resource delivering apparatus of claim 1, wherein the control parameters are a plurality of priorities corresponding to the delivery planning commands.

3. The automatic resource delivering apparatus of claim 1, wherein when the flow control scheme is not enabled, the control server generates the corresponding action command directly according to each of the delivery planning commands.

4. The automatic resource delivering apparatus of claim 1, wherein when the flow control scheme is enabled, the control server generates the corresponding action command or transmits each of the delivery planning commands to the command queue according to each of the control parameters and the control logic corresponding to each of the delivery planning commands.

5. The automatic resource delivering apparatus of claim 1, wherein the flow control scheme is enabled when the data bank apparatus determines that the amount of the delivery planning commands is greater than a first threshold, and the flow control scheme is disabled when the data bank apparatus determines that the amount of the delivery planning commands is less than a second threshold, wherein the first threshold is greater than the second threshold.

6. The automatic resource delivering apparatus of claim 1, wherein when at least one of the delivery planning commands is stored to the command queue, the data bank apparatus sets the delivery planning command to be a queued state.

7. The automatic resource delivering apparatus of claim 6, wherein when the flow control scheme is disabled, if the queued state is set, the data bank apparatus sequentially transmits a plurality queue delivery commands in the command queue by different times and different amounts to the control server, and the control server generates a corresponding action command according to the queue delivery commands in order to execute a complementary resource delivering operation.

8. The automatic resource delivering apparatus of claim 7, wherein the complementary resource delivering operation is stopped when the flow control scheme is enabled.

9. The automatic resource delivering apparatus of claim 7, wherein when the queued state is set, the control server determines a resource state of a delivery destination corresponding to each of the queue delivery commands, and stops the complementary resource delivering operation corresponding to each of the queue delivery commands when the resource state indicates that a resource at the delivery destination corresponding to each of the queue delivery commands is full.

10. The automatic resource delivering apparatus of claim 7, wherein when the queued state is set, the control server stops the complementary resource delivering operation corresponding to each of the queue delivery commands when determining that changes occurred on a location and a state of a resource delivering carrier corresponding to each of the queue delivery commands.

11. The automatic resource delivering apparatus of claim 7, wherein during the complementary resource delivering operation, the data bank apparatus sequentially transmits each of the queue delivery commands according to a plurality of priorities respectively corresponding to the queue delivery commands.

12. The automatic resource delivering apparatus of claim 7, wherein during the complementary resource delivering operation, the data bank apparatus records an execution state of the complementary resource delivering operation.

13. The automatic resource delivering apparatus of claim 1, wherein the delivery planning commands comprises a plurality of local delivery commands and a plurality of inter-regional delivery commands.

14. An automatic resource delivering method, suitable for a semiconductor manufacturing plant, and comprising:
generating a plurality of delivery planning commands according to a plurality of dispatching instructions, respectively;
deciding whether to enable a flow control scheme according to an amount of the delivery planning commands, and transmitting a plurality of control parameters corresponding to the delivery planning commands to the control server;
temporarily storing each of the delivery planning commands to a command queue according to whether the flow control scheme being enabled, the control parameter corresponding to each of the delivery planning commands and a control logic, or generating an action command according to each of the delivery planning commands; and
executing a resource delivering operation according to the action command.

15. The automatic resource delivering method of claim 14, wherein the control parameters are a plurality of priorities corresponding to the delivery planning commands.

16. The automatic resource delivering method of claim 14, wherein the flow control scheme is enabled when the amount of the delivery planning commands is greater than a first threshold, and the flow control scheme is disabled when the amount of the delivery planning commands is less than a second threshold,
wherein the first threshold is greater than the second threshold.

17. The automatic resource delivering method of claim 14, further comprising:
setting a queued state when at least one of the delivery planning commands is stored to the command queue.

18. The automatic resource delivering method of claim 17, wherein when the queued state is set, the automatic resource delivering method comprises:
transmitting a plurality of queue delivery commands in the command queue by different times and different amounts according to the priorities; and
generating a corresponding action command according to the queue delivery commands in order to execute a complementary resource delivering operation.

19. The automatic resource delivering method of claim 17, wherein when the queued state is set, the automatic resource delivering method further comprises:
stopping the complementary resource delivering operation when the flow control scheme is enabled.

20. The automatic resource delivering method of claim 17, wherein when the queued state is set, the automatic resource delivering method comprises:
determining a resource state of a delivery destination corresponding to each of the queue delivery commands, and stopping the complementary resource delivering operation corresponding to each of the queue delivery commands when the resource state indicates that a resource at the delivery destination corresponding to each of the queue delivery commands is full.

21. The automatic resource delivering method of claim 17, wherein when the queued state is set, the automatic resource delivering method comprises:
stopping the complementary resource delivering operation corresponding to each of the queue delivery commands when determining that changes occurred on a location and a state of a resource delivering carrier corresponding to each of the queue delivery commands.
